(19) United States
(12) Patent Application Publication
(10) Pub. No.: US 2008/0209330 A1
(43) Pub. Date: Aug. 28, 2008

(54) System and Method for Collaborative and Interactive Communication and Presentation over the Internet

(76) Inventor: Wesley Cruver, Sterling, VA (US)

Correspondence Address: MAXVALUEIP CONSULTING, 11204 ALBERMYRTLE ROAD, POTOMAC, MD, 20854, US

(21) Appl. No.: 12/036,226

(22) Filed: Feb. 23, 2008

Related U.S. Application Data
(60) Provisional application No. 60/891,499, filed on Feb. 23, 2007.

(51) Int. Cl. G06F 15/16

(52) U.S. Cl. 715/733

(57) ABSTRACT

A novel interactive system for E-learning and Tele-conferencing via the Internet is described that integrates video, audio, slides, text and other required means of communication in a simple to use platform. The system allows presenter to poll audience and see the results. The system records the session for future Video-On-Demand viewing. The KZO platform could be locally installed at customer premise or it could be located in KZO or other service provider hubs. The video and audio streaming is based on open-source Flash technology, or any other similar technologies.

### CROSS REFERENCE TO THE RELATED APPLICATIONS

This application is related to a provisional application 60/891,499, filed 23 Feb. 2007, on the same topic, with the same inventor, and a related assignee.

### BACKGROUND OF THE INVENTION

The internet is becoming the primary method of communication in corporate, educational and social settings and video is surpassing audio and text as the preferred method of communications. E-learning, E-conferencing and E-presentation are various services which require a system that can combine and integrate video, audio, text, pictures and presentations seamlessly in an easy to use environment.

There is a need in the industry for effective and interactive internet-based communication to a geographically dispersed audience for training, teleconferences, and/or contingency operations. Universities, colleges and other organizations need the ability to deliver lectures and presentations to their audiences in the form of both live and recorded video, in an interactive, easy to use platform combined with simple hardware, streaming video (i.e. web cast) and the internet Presenters want to control the presentation, to poll the audience and to answer live questions and to see the results at the presentation time, without the need for using multiple discrete technologies or video resources. There is a need to reduce the time to chapterize, index, store and archive live broadcast video for subsequent video-on-demand viewing.

Many solutions exist today that either do not fully integrate all the above mentioned required features or are not affordable. The challenge is in integrating these forms of communication and features seamlessly and at an affordable price.

### SUMMARY OF THE INVENTION

This invention is a unique, simple yet elegant interactive system for E-learning and Tele-conferencing via the internet. It integrates video, audio, slides, text and other required means of communication in a simple to use platform. The presenter has the ability to poll audience and see the results, and the audience has the ability to ask questions and see the progress of the session, all in a full interactive environment. The presenter has the ability to pre-chapterize the presentation and to prepare pre-polls. The system records the session while in progress and therefore is accessible as Video-On-Demand (VOD) as soon as the session is finished. The invented system comprises of a number of hardware and software elements, which are installed on the KZO platform. The KZO platform could be locally installed and hosted at the customer premise or it could be located in KZO or other service provider hubs. The system is completely secured and can be integrated with existing authentication systems for logging in by both presenter and audience. The video and audio streaming is based on Flash video technology, or any other streaming video technology. Other video formats, such as Silverlight, can also be used.

### BRIEF DESCRIPTION OF THE DRAWINGS

FIG. 1 is a schematic diagram showing the KZO servers and Client elements. Flash technology is currently used for video and audio streaming but can be adapted for any streaming video technologies.

FIG. 2 is a data flow diagram showing the flow of data from the presenter to KZO servers and from KZO servers to the clients. It shows both local and remote recording of the session for subsequent viewing as video on demand. The hardware, server, and OS can be any brand or type.

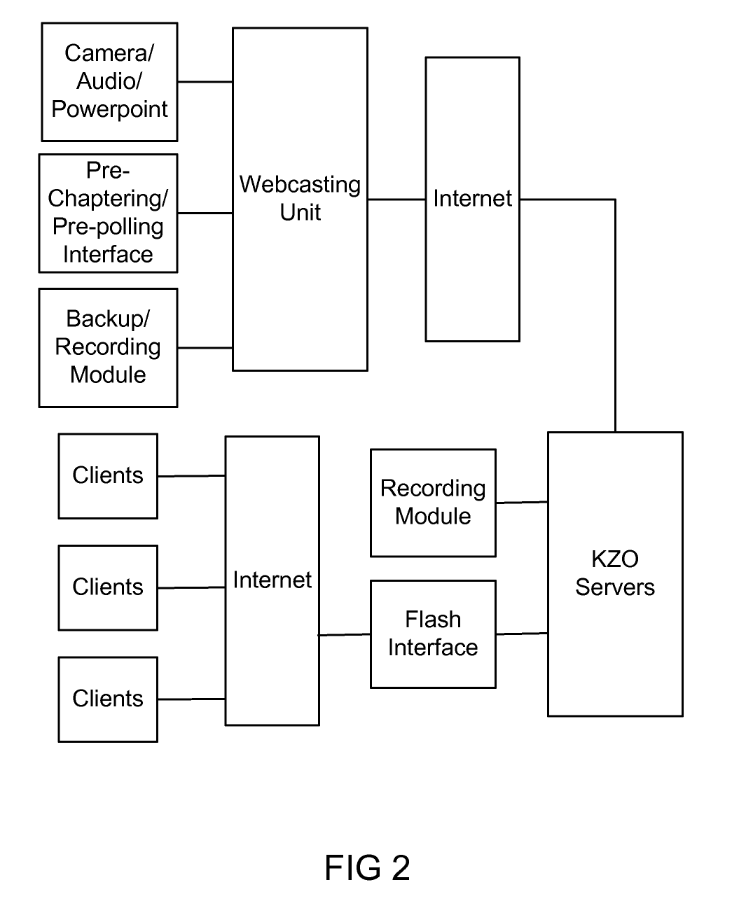

FIG. 3 shows the KZO platform (vPlatform).

FIG. 4 shows the individual data flows between presenter, KZO server and clients.

FIG. 5 shows the flow of events for a presentation session, which starts in a presentation location and is webcast live to the audience, which is recorded for viewing as video on demand. It also shows that polls can be taken and results presented graphically.

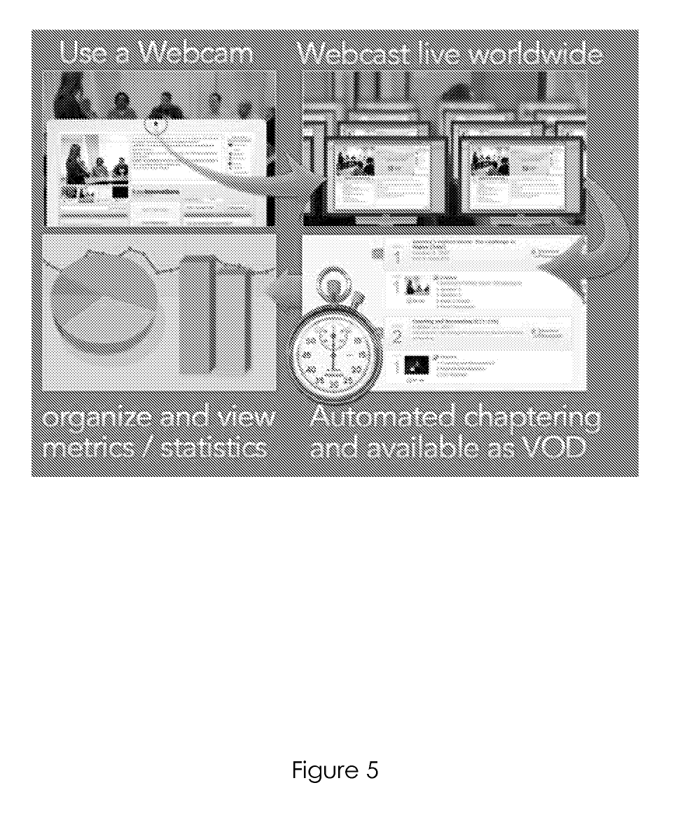

FIG. 6 illustrates the pre-chaptering menu as seen by the presenter. It shows the completed, selected and remaining chapters.

FIG. 7 shows the complete screen seen by the presenter. It comprises of a pre-chaptering, pre-polling, who's on-line, chat text, and video/audio sections.

FIG. 8 shows the screen seen by audience when the presenter has pushed a poll. The audience could answer and submit the answer.

FIG. 9 shows the results of a poll taken by the presenter on the presenter's screen.

### DETAILED DESCRIPTION OF THE PREFERRED EMBODIMENTS

KZO Innovations (KZO) has developed real-time collaboration-based digital tools for web casting applications. KZO has incorporated its unique digital tools into an interactive, collaboration-based video platform to assist organizations with their e-Learning, training, and communications demands.

The market for e-Learning is transforming the educational landscape because advanced technology allows students to remotely attend virtual classes to pursue degrees rather than commuting to physical classrooms. Disruptive technologies are emerging as hosted solutions and new “open-source” products gaining traction in the higher education market are increasingly being adopted in other major e-Learning market segments.

KZO's unique technology provides organizations with the ability to deliver lectures and presentations to remote audiences. It employs both live and recorded video in an interactive, easy-to-use platform combined with simple yet sophisticated video hardware, streaming video and the internet. All are controlled by the presenter at the presentation level, without the need for additional technology or video resources.

In addition to being capable of web casting live lectures, presentations can be integrated into the customer's registration system and Learning Management System (LMS). The platform also has the ability to track user metrics and push live poll and quizzes to the online audience.

The KZO Platform can be used in a “Software as a Service” (SaaS) webcast offering basis. SaaS allows organizations to produce live and VOD webcasts without any special hardware or software. SaaS simply uses the internet to connect to a KZO platform that is located at a service provider hub. SaaS reduces the capital cost of buying and installing the KZO platform. SaaS also removes the need for organizations to handle the installation, set-up and daily upkeep and maintenance. KZO has unique technological resources that serve to distinguish its capabilities such as operating a high capacity optical network which privately peers with numerous networks.

### KZO Optical Network

KZO has constructed a Network Operations Center (NOC) on an 8 Gigabit Fiber Optic backbone connecting to one of the world's largest Internet Service Providers. This gives KZO the ability to stream approximately 26,000 simultaneous broadband videos. The KZO network architecture is further empowered by its co-location in one of the largest network ‘peering’ centers managed by Equinix. Peering partners negotiate and provide direct exchange of network traffic with each other, thereby avoiding congestion and optimizing performance. KZO's extensive peering network significantly improves the performance, quality of streaming video, and reduces cost.

KZO Platform (Also Called vPlatform)

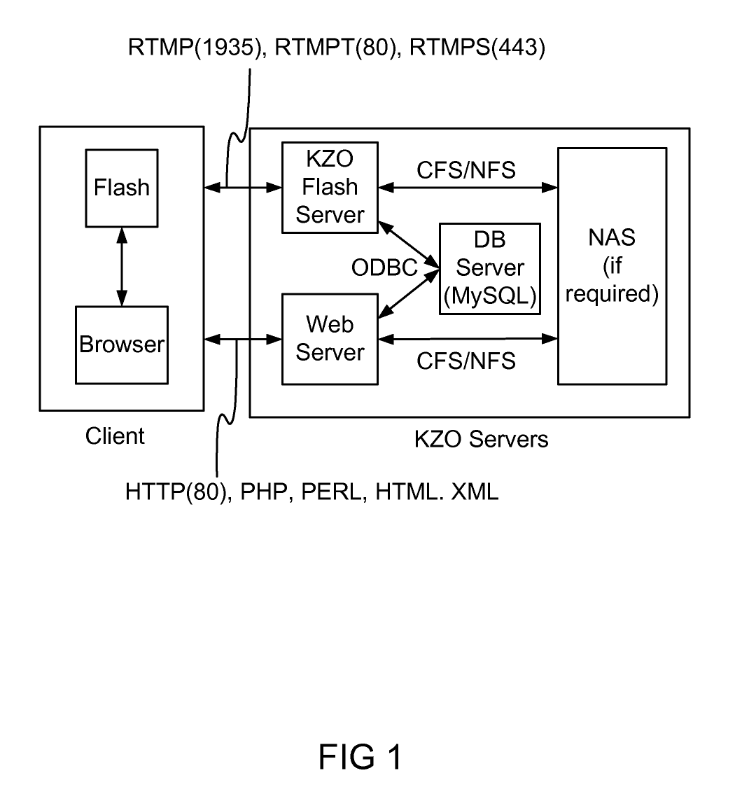

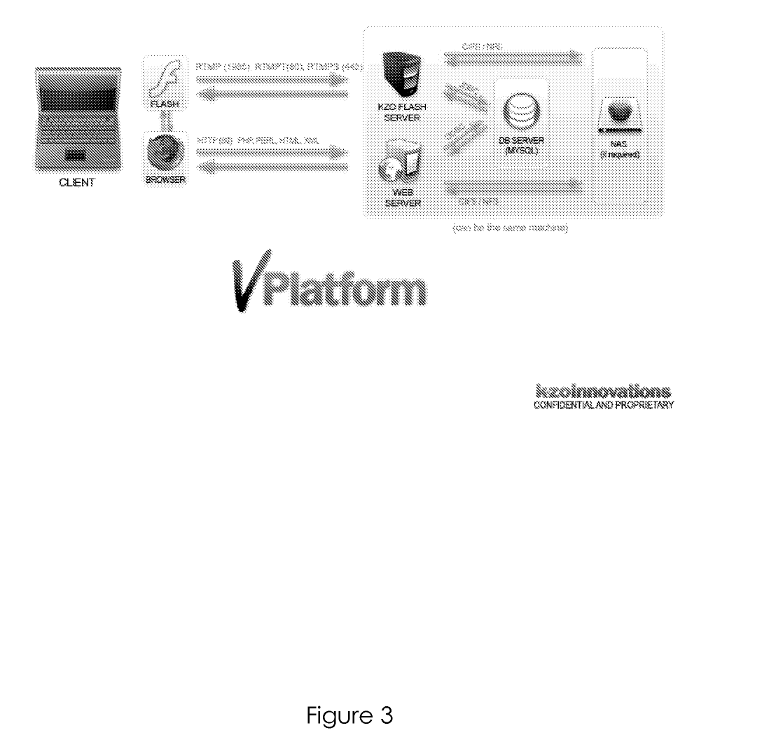

The KZO Platform is shown in FIG. 1 and FIG. 3. The KZO Platform can be used as a service which can be either hosted on the KZO 8 gigabit optical network or loaded on a server for the customer's network. Applications are written in Java and employ Flash technology to allow media to stream through the browser—not a video player, making the KZO application simple, easy to use and eliminating the need for third party applications, i.e. Windows Media, Real-Video and Quick-Time. KZO performs the following functions:
1. Provides the ability to live webcast and concurrently record lectures into abbreviated “chapters” for subsequent immediate viewing.
2. Provides a wizard to pre-chapter e-Learning lectures into short learning objects which are tagged in real time during the lecture.
3. Provides a mechanism that records the “chaptered” lecture onto the Flash video platform system without the need for later uploading.
4. Provides a Flash-based interactive e-Learning method incorporating features such as real-time chats, quizzing, polling, and Q&A.
   KZO vCapture

The principal components for the mobile content creator are a compact computer loaded with KZO's proprietary software, a codec license, and an encoder card. This encoder card takes the video and audio signal from the live presentation, digitizes it, then transmits the data in real-time to a KZO Platform over an internet connection. The video is recorded on a broadcast-quality, 3 chip robotic cameras that can be pre-set for a variety of shots: for example, tight and wide views of the presenter, left side of the audience, and right side of the audience. This allows the presenter to easily include participation in the web cast.

KZO's polling technology drives a number of interactive and collaborative features between the presenter and the viewers. This polling feature allows the presenter to deliver polls and questions to the viewers to gauge general comprehension, receive feedback, and evaluate the effectiveness of the lecture.

### KZO SaaS

In addition to the enterprise KZO Platform with accompanying VCapture technology, KZO platform can be used in Software as a Service (SaaS) solution as a low introductory cost and scalable solution for executive briefings, product updates, reseller/partner training and research collaboration. SaaS allows organizations to produce live and VOD webcasts at a cost less than paying for licensed applications since SaaS pricing is based on a monthly or yearly fee. SaaS also removes the need for organizations to handle the installation, set-up, and maintenance. With an inexpensive webcam and for low monthly SaaS fees, organizations can produce web casts that can be viewed live and subsequently as VOD by anyone with an internet connection and a browser.

### KZO Architecture

Interactive and collaborative Web 2.0 technologies are storming the internet, and streaming live broadband video is commanding center stage. Moreover, open-format technologies are gaining momentum in higher education and the Federal Government which are adopting open-source and open-format solutions as low-cost alternatives to commercial software without the fear of being locked-in to a proprietary format.

There are three major open-source components in the KZO technology, which are also shown in FIG. 1 and FIG. 3: (Please note that these are just examples, and any specific manufacturer's product, or open-source (or non-open source) solution, software, or hardware, can also be used.)
1. MySQL: KZO employs MySQL just as its database to hold user information, video locations, etc.
2. Apache: This is the HTTP server. KZO writes web applications in PHP, with the exception of the uploading, which is written in Perl. The entire user management, administrative tools, course management, and login system are written in PHP, and served over HTTP. Basically, until a user views a video, they are being served data via Apache.
3. Flash Video Server: Once a user views a video, the Flash interface is launched and makes an RTMP, RTMPT, or RTMPS connection to the KZO Red5 server (or Wowza). Much like Apache, the Flash video server is an engine that handles network connections and the transmitting of data.

For presentations requiring PowerPoint, KZO parses the PPT file, and exports it into a series of JPGs, which can be easily sent and viewed using a standard web browser. This is controlled by the Flash video application in a manner similar to advancing a typical PowerPoint presentation. Application elements beyond the above open-source components have been written by KZO developers and are proprietary. KZO's applications creates the virtual rooms, captures the PPT and chapter triggers, handles polling and chatting, captures the video/audio, etc.

Additional proprietary software, invented by KZO, is the presenter application that runs on a Windows machine and is used by presenters to capture their lectures. It features a 4-input live switcher, is HD capable, and is written in C#, as an example. Additionally, a version was written entirely in Flash ActionScript that allows users to connect and send steaming video via a Webcam.

### Features

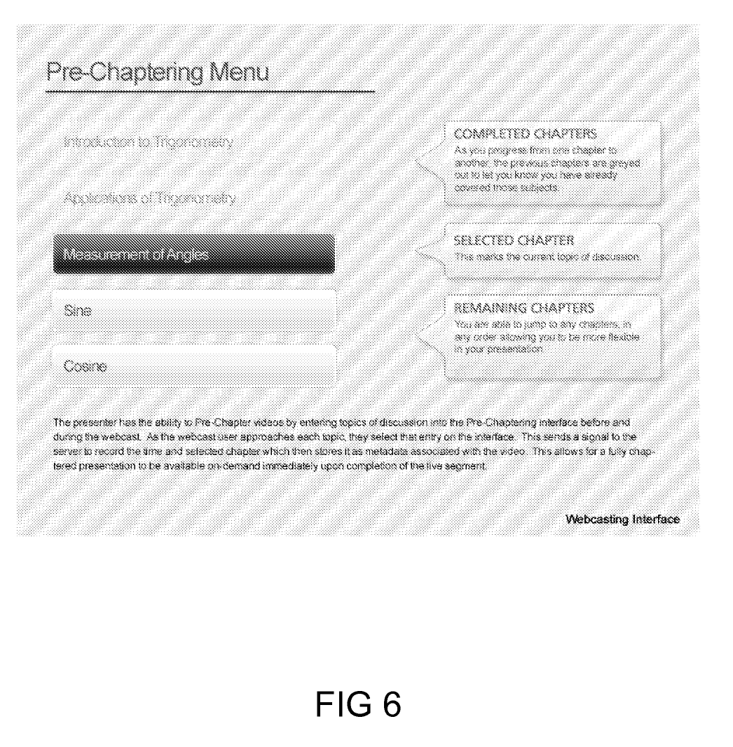

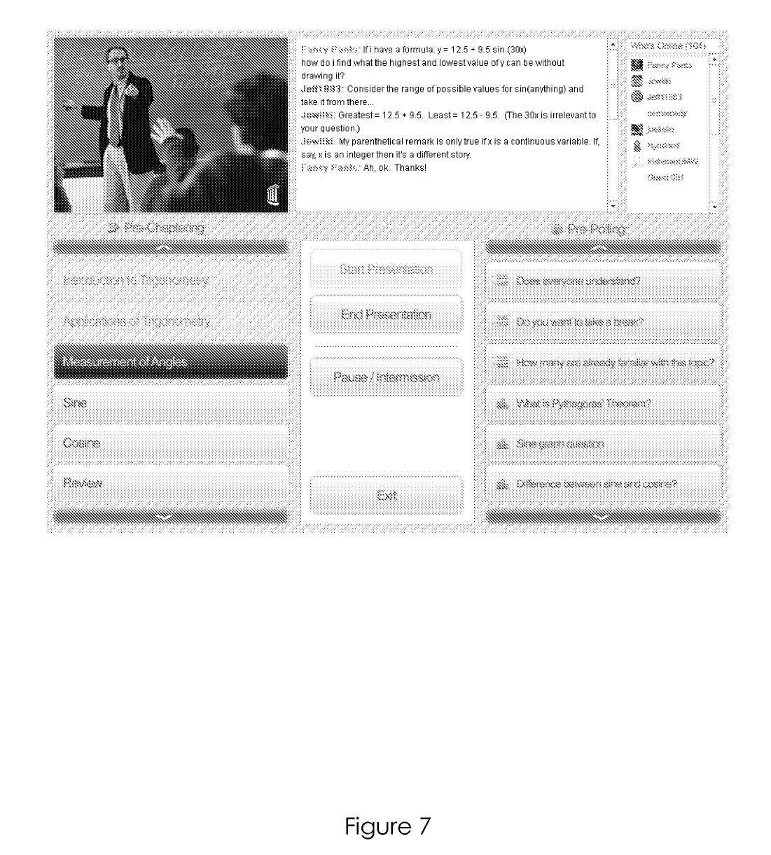

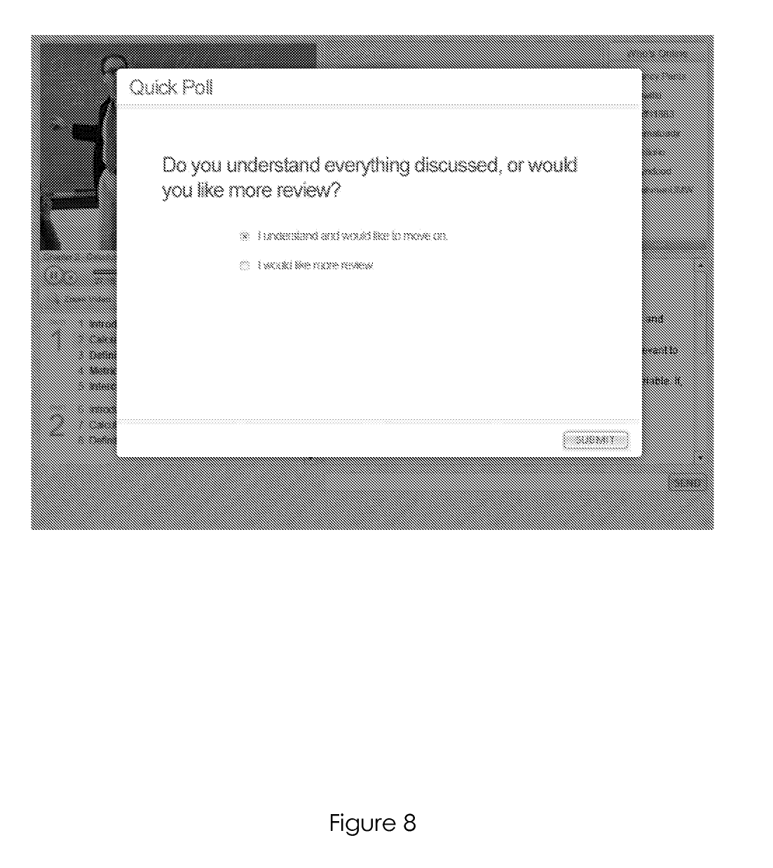

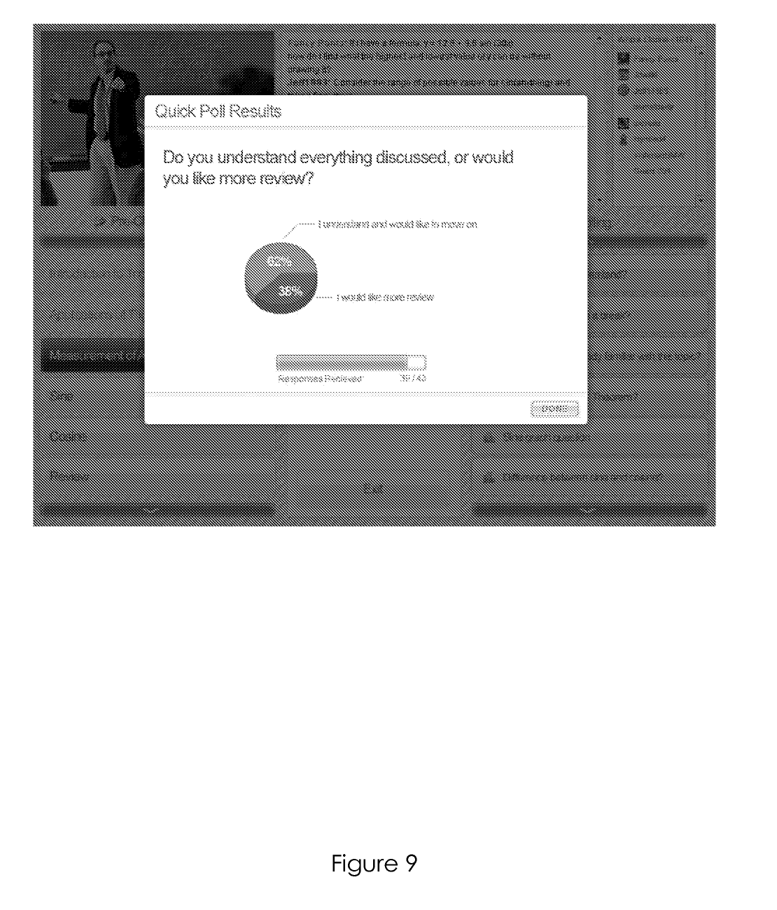

Remote Video Switching: Traditional video switching accepts a variety of video inputs and can cut between those inputs to produce one output. The downside to this type of technology is that at some point, you have to have a physical connection to that video, and an expensive piece of hardware. KZO's remote video switching technology achieves the same result of switched video, but requires no expensive hardware and allows a virtually unlimited number of inputs. It achieves this by encoding video from any number of sources over the internet. The multiple sources of video are sent to a server where the director can view them, and choose which stream to broadcast to the participants. This can be done by either selecting different input streams on the server, or by forcing all participants to attach the video viewer onto a new video stream.
User-Selectable Video Switching: This method works similarly to the Remote Video Switching, but instead of a single director forcing each user to switch the video stream they receive, the end-user can select which stream they wish to view. A good example would be in a classroom environment, where using the KZO software, the professor can transmit several live camera feeds to the server. Instead of the professor assuming that all their students should be viewing the blackboard and forcing that input upon them, the students can now pick and choose which camera or video source they wish to view.
Pre-Chaptering:
   Chaptering a presentation allows users to jump to particular areas within that presentation giving the viewer immediate access to the information they are seeking. The actual process towards chaptering content can be long and tedious, often taking as much time to complete as the length of the video. For example, if an instructor is giving a three hour lecture and an instructor's assistant records it on video, the general rule of thumb is that the video will take roughly six hours to chapter (three hours for the time it takes to record the lecture on camera, and another three hours to watch the lecture and segment it into chapters).
   Pre-Chaptering gives presenters the ability to chapter their presentation in real time, and makes it immediately available online with no additional work or time required. The concept being that the chapters or topics of discussion are entered prior to the start of the presentation. As each topic of discussion is approached, the presenter simply selects that item, and the Pre-Chaptering program sends a message to the server indicating the time that the chapter changed, and which chapter was selected. The pre-chaptering menu is shown in FIG. 6.
Pre-Polling:
   As part of the KZO Platform, Pre-Polling provides the functionality behind a number of interactive and collaborative features between the presenter and the viewers.
   In an educational environment, instructors have the benefit of real life feedback such as students raising their hands, a general look of confusion, etc. When dealing with a virtual audience the need for collaboration and interactivity becomes very important.
   The Polling feature allows the presenter to push polls and questions to the viewers to gauge general comprehension levels, get feedback, test the effectiveness of the lecture thus far, etc. Pre-Polling, like Pre-Chaptering, allows the instructor to create these polls, quizzes, and questions in advance and simply select them when they wish to push it to the viewers (FIG. 7). As an example, if an instructor is wrapping up a segment, he or she can simply click on a general feedback question, such as “Do you understand everything, or would you like more review?” This question gets sent to each student participating (FIG. 8) and the results are sent back to the instructor in real time (FIG. 9).
No Uploading
   The method of immediately allowing on demand viewing after a live presentation without the need for uploading is achieved by recording all input from the presenter (camera, sound, chapters, polls and PowerPoint) on the server. When the live presentation finishes, the server immediately makes the chaptered recording available as an archived (on-demand) presentation.
Multi-versioning control for SaaS: Businesses using Software as a Service (SaaS) models are subject to large numbers of customers with varying requirments. Interfaces can be developed with themes that can be altered from one customer to another to help address the aesthetic differences between one another, but software versions and features are much more difficult to address. Generally, when running a SaaS application, only one application is created, and each new customer is simply a new instance of that application. This makes changes and bug fixes far easier to address, as these only have to be updated in one location, as opposed to updating each customer's application. These bug fixes are generally welcomed by all customers, however, feature upgrades and additions are far more subjective. Many customers prefer to stick to what they know especially if training and documentation materials have already been created.
   KZO has invented a method of loading controls, applications, and features during runtime, which can assess which client is loading the application, and their preferred version and features. Each new feature and module is a separate object that gets loaded at runtime and inherits any properties or methods of the previous module. Therefore, updates and bug fixes are easily implemented, but also allow multiple versions of the same software to run concurrently.
   This same method also works well for restricting higher priced features from being accessed or used by lower paying customers. The customer simply pays for what they use and those modules are loaded accordingly.
Flash based: The de-facto standard for emerging video websites is Flash based due to its superb quality, low bandwidth requirements and universal viewing capability regardless of the viewer's operating system. We can also switch to other formats and browsers.
Browser based: Streaming video, interactivity and collaboration directly through the browser are very useful for the user, compared with traditional downloaded and installed applications. Users no longer have the patience to download and install a clunky client, and those that do are often restricted due to tightened security and firewalls.
Streaming Server: Viewers stream the video directly from the server utilizing dynamic and interactive viewing interfaces, avoiding security and copyright issues when the video is downloaded onto the computer for viewing. Streaming the video provides an additional layer of security and control which is critical for protecting intellectual property from theft and repurposing.
Replicates classroom environment: Live real-time web casts around the globe; Live-polling and chat enabling student feedback; PowerPoint presentation and consistent delivery of high definition (HD) quality streaming video and audio.
Content “Chapterization”: Permitting instructors to create on-the-fly reusable learning objects that students can then replay as VOD.
Flexibility: Realign video “chapters” into new VOD lessons. Allow students unable to attend the live broadcast to view the recorded session using a simple web browser.
Ease of integration: Ease of integration with existing registrations systems, Learning Management Systems (LMS), and LDAP/Active Directory systems.
Content Management: Enormous amounts of valuable programming can be inexpensively produced and archived into a searchable digital repository for subsequent “anyplace, anytime” learning.
Customized Features: No need to get accustomed to a different look. The KZO Platform can be customized to create the look and feel of your particular brand and standards.
Course Management: The administrator functionality that is built into the platform provides the instructor the ability to easily control and manage their courses and restrict access to particular users, or groups of users.

Benefits
“Anyplace, anytime” learning.
Quick, simple and immediately usable e-Learning and communications content.
Valuable lectures and presentations can be produced quickly and inexpensively.
Real-time simultaneous posting of content allowing for subsequent VOD.
Ease of integration with existing registration systems and Learning Management Systems (LMSs).
Look and feel customized for customer brand and standards.
Eliminates technology resources, video editors, and camera operators.
Capable of producing live high-quality Flash streaming video including Hi-Definition video—directly from your laptop or personal computer.
Dual-screen, synced to presentation slides with real-time chaptering, “Chat”, “Who's Online”, and “Polling” features.
Real-time chaptering into Learning Objects created from a “wizard” to assist the presenter.
Administrator functionality built into the platform for presenter to edit and manage.
Features are database-driven with results searchable from a digital repository.
Seamless integration of blogs, wikis, and other interactive Web 2.0 features.

### KZO Platform on Sun

Here is one example of the implementation, and other products can also be used: The open-source Flash server provides opportunities beyond the sale of the product by providing services and value delivered around the product. KZO believes that a combination of open-source and proprietary solutions may be the answer for creating an infrastructure stack of services based upon the customer's requirements.

KZO's streaming solution has been tuned to take full advantage of the Sun Fire™ T1000 and T2000 servers, as examples of implementation. Sun designed the Solaris 10 operating system for chip multithreading giving Ultra™SPARC TI-based systems new functionality for optimized utilization, relentless availability, unparalleled security, and extreme performance. Containers zones provide a secure, isolated, virtual environment for separating KZO's application framework; the Solaris ZFS file system takes the complexity out of volume management by using pooled storage. Finally, since security was a chief concern to KZO and their customers, process rights management profiles were created to reduce the privileges associated with each KZO application, as one embodiment/example.

### KZO Applications

### Corporate Communications

1. Executive briefings

2. All-hands meeting

3. Press conferences

4. Board meetings

5. Research collaboration

6. Product road map updates

7. Online advertising

8. Company announcements

9. Corporate newsletter

10. Event documentation

### Workforce Development

11. HR training

12. Recruitment presentations

13. Interviews/candidate

14. selection

15. New employee welcome

16. Corporate policy

17. documentation

18. Building orientation

19. 401k overview

20. Benefits training

21. Office procedures

22. Global travel and customs training

23. Guest/visitor orientation

### Sales and Marketing

24. Sales training

25. Webinars

26. Digital personal introductions

27. Sales presentations

28. Sales call follow-up

29. Product announcements

30. Reseller/partner training

31. Online product overviews

32. Product/service

33. demonstrations

34. Customer testimonials

35. Digital holiday greeting

### Entertainment Media

36. Breaking news

37. Expanded news coverage

38. Sporting events

39. Post game analysis interviews

40. Home improvement how-to

41. Craft lessons (e.g. scrapbooking)

### Customer Support

42. Product tutorials

43. Customer service/FAQs

44. Self-guided troubleshooting

45. Maintenance bulletins

46. Product reviews

47. Technical tips

48. Recall information

### Investor Relations

49. Company introduction

50. Earnings calls

51. Annual report

52. Investor updates

### Government

53. Public safety announcements

54. Relief work coordination

55. Town hall/committee meetings

56. Virtual tour for tourism or business

57. Travel warnings

58. Road construction updates

59. Public transit overview

60. Recycling instructions

61. Police alerts

62. Public speeches

63. Constituent communication

64. Legislative proceedings

65. Legislative process training

66. Campaign debates

67. Military coordination and briefing

68. Military recruitment

### Legal

69. Continuing legal education

70. Courtroom recordings

71. Depositions

72. Witness interviews

73. Evidence documentation

### Events/Conferences

74. Keynote speaker address

75. Conference presentation

76. Broadcasting to event overflow room

77. Trade show announcements

78. Post conference follow-ups

### Health

79. Grand rounds

80. Telemedicine

81. Self-help/on demand information

82. Continuing medical education

83. Emergency response coordination

84. Caregiver training

85. CPR instruction

86. Pre- and post-operation instructions

87. Nutrition and diet guidelines

88. Insurance/benefit coverage information

89. Parenting classes

### Education

90. Distance learning

91. Recorded lectures

92. Self-guided study

93. Student recruitment

94. Parent/student orientation

95. Campus virtual tours

96. Study abroad introduction

97. Financial aid instructions

98. Board/regent meetings

99. Instructor certification

100. Alumnae relations

### Non Profit/Association

101. Board and committee meetings

102. Policy briefings

103. Digital newsletter

### KZO Platform Flow of Events

There are two separate flows of events for Live and VOD viewing. For this document/disclosure, we will be focusing on the VOD portion, as it is generally the most taxing on the system.

In a typical session, a client requests a presentation from the web server. The response provides the Flash client application with the necessary information to request more detailed information directly from the KZO Platform. The Flash application then makes a connection to the KZO Platform and passes along information about the username, the client (when multiple clients are hosted on one system), the proper scope, and other ancillary data. Concurrently, it requests Chapter information, PowerPoint slides/cue times, Closed Captions, and other data associated with the presentation from the web server. As this happens, the KZO Platform creates a new “room” based on the scope provided by the client. This is done to allow users to collaborate around a particular presentation, without interfering with other users collaborating around different presentations.

When the Flash client has enough information and is properly connected, it requests the playback of the video chosen from the “playlist” (a playlist is a collection of videos associated with a particular presentation and gets played continuously as one video). At this point, the KZO Platform has already created the scope, and created new objects to hold information about the users, and the chat dialog. The KZO Platform then loads the requested video into ram from the file system, and streams requested portions to the end user.

Finally, when the user has completed viewing the presentation, they close the Flash application, which disconnects the session from the KZO Platform and removes the user from all objects. Additionally, the KZO Platform alerts all other users in the “room” to the disconnection, and begins running garbage collection to free up memory for subsequent users.

For obvious reasons, this flow of events is designed to be brief. There are many more events that occur, that either do not directly affect the KZO Platform, or have such low memory and processor utilization, that they were omitted for simplicity.

### Data/Process Flow

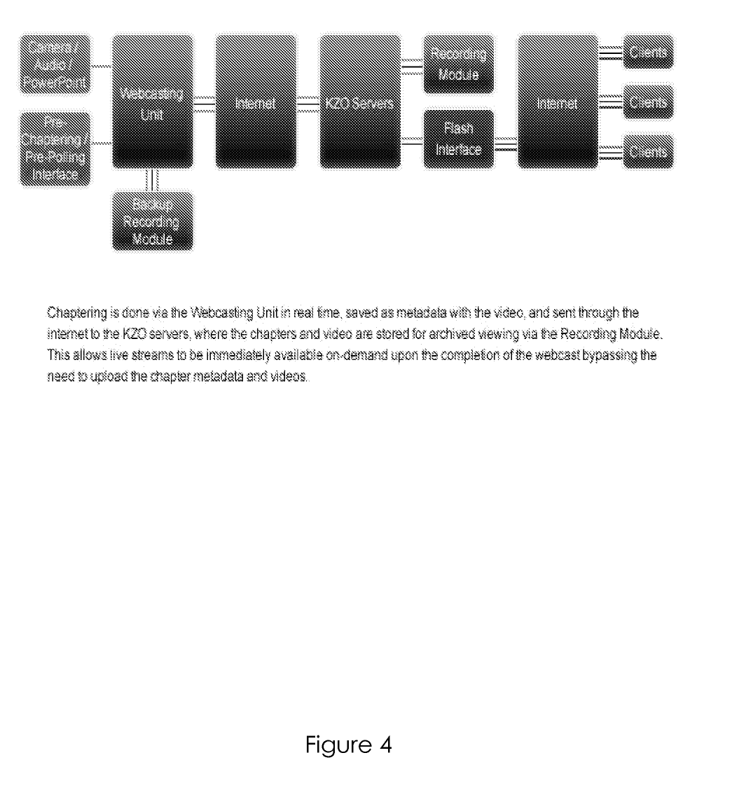

The data/process flow is shown in FIG. 4. A live presentation starts at a university, conference hall, auditorium, or anywhere else a presentation can be given. Using a video camera, microphone, and the KZO software, the presenter plans out their lecture by entering the agenda into the Pre-Chaptering interface (FIG. 6 and FIG. 7).

The webcasting unit encodes the video and audio data into Flash video and saves it locally via the backup recording module. As it saves the backup, it sends that data, along with the chapter and polling data, to the KZO Platform. The server then records the audio, video, chapter and polling data using a Recording Module and also sends it out to the live participants.

### Technical Implementation

The KZO Platform application currently sits on top of a Flash video server, but can be adapted to work with many different alternatives including Adobe Flash Communication Server, Wowza Media Server, Microsoft Silverlight, etc. These servers provide the engine to build the application to handle the chaptering, polling, collaboration tools, and video recording.

The KZO Platform listens for information from the presenter regarding chapter changes and which polls to push and stores that information in a database or XML file. A Java example of one such operation is shown below.

### Example of Java/XML Code Running on KZO Server, as One Embodiment:

import javax.xml.parsers.*;
import java.io.*;
import org.w3c.dom.*;
import javax.xml.transform.*;
import javax.xml.transform.dom.DOMSource;
import javax.xml.transform.stream.StreamResult;
public class XmlTimer implements ISharedObjectListener {
private static final Log log = LogFactory.getLog(Application.class);
private Document document;
private Element content;
private int xmlIndex = 0;
private long startTime;
private boolean isFirstTime = true;
private int count = 0;
private String filepath;
public XmlTimer(String wbpath)
{
filepath = wbpath;
buildDom( );
}
private void addMarker(String value)
{
long elapsed_time = (System.currentTimeMillis( ) − staff Time) / 1000;
// add marker to xml ////////
Element marker = document.createElement(“marker”);
content.appendChild(marker);
marker.setAttribute(“sec”, elapsed_time+“”);
marker.setAttribute(“value”, value);
}
public String getMessage( )
{
return “Xml Timer Class!!”;
}
private void buildDom( )
{
DocumentBuilderFactory factory =
DocumentBuilderFactory.newInstance( );
try {
DocumentBuilder builder = factory.newDocumentBuilder( );
document = builder.newDocument( );
} catch (ParserConfigurationException pce) {
pce.printStackTrace( );
}
content = document.createElement(“points”);
document.appendChild(content);
}
public void saveXml( )
{
document.getDocumentElement( ).normalize( );
try
{
// Use a Transformer for output
TransformerFactory tFactory =
TransformerFactory.newInstance( );
Transformer transformer = tFactory.newTransformer( );
xmlIndex++;
DOMSource source = new DOMSource(document);
StreamResult result = new StreamResult(new
File(filepath+xmlIndex+“.xml”));
transformer.transform(source, result);
} catch (TransformerConfigurationException tce) {
// Error generated by the parser
System.out.println (“\n** Transformer Factory error”);
System.out.println(“ ” + tce.getMessage( ) );
// Use the contained exception, if any
Throwable x = tce;
if (tce.getException( ) != null)
x = tce.getException( );
x.printStackTrace( );
} catch (TransformerException te) {
// Error generated by the parser
System.out.println (“\n** Transformation error”);
System.out.println(“ ” + te.getMessage( ) );
// Use the contained exception, if any
Throwable x = te;
if (te.getException( ) != null)
x = te.getException( );
x.printStackTrace( );
}
// CLEAR XML CONTENT FOR NEW XML
document.removeChild(content);
content = document.createElement(“points”);
document.appendChild(content);
} // END OF SAVEXML
// methods for ISharedObjectListener implementation
public void onSharedObjectUpdate(ISharedObject so,
String key, Object value)
{
String objValue = value.toString( );
if(isFirstTime)
{
isFirstTime = false;
log.info(“This is first time ini Xml timer file”);
startTime = System.currentTimeMillis( );
}
log.info(“RSO Update form XmlTimer: -- key: ” + key + “ --Value: ” +
objValue);
if(objValue.equals(“−1”))
{
saveXml( );
isFirstTime = true;
return;
}
addMarker(objValue);
}
public void onSharedObjectDelete(ISharedObject so, String key){
}
public void onSharedObjectSend(ISharedObject so, String method,
List params){
}
public void onSharedObjectDisconnect(ISharedObject so){
}
public void onSharedObjectClear(ISharedObject so){
}
public void onSharedObjectConnect(ISharedObject so){
}
public void onSharedObjectUpdate(ISharedObject so, IAttributeStore
values){
}
public void onSharedObjectUpdate(ISharedObject so, Map<String,
Object> values){
}
// END OF ISharedObjectListener implementation
} // END OF CLASS

The KZO Presenter application runs as a flash file, which connects to the server application to inform it of chapter changes and polling pushes. An example of a presentation program is shown below.

### Example of KZO Flash-Based Presenter Application Software, as One Embodiment:

// FCS connections and shared Object
import org.red5.utils.remote.GlobalObject;
import mx.utils.Delegate;
import mx.controls.Button;
var nc:NetConnection;
var so:GlobalObject;
var connected:Boolean;
var slideurl = “http://server.com/slides/”
function iniConnect( ):Boolean
{
this.nc = new NetConnection( );
this.nc.onStatus = Delegate.create(this, this.ncOnStatus);
var connected:Boolean = this.nc.connect(this.rtmpURI.text);
return connected;
}
// status for the netconnection
function ncOnStatus(obj:Object):Void
{
if(obj.code == “NetConnection.Connect.Success”)
{
conntext.text = “Connected!”
iniSharedObject( )
}
}
function iniSharedObject( )
{
so = new GlobalObject( )
// add listener for sync events
connected = so.connect(“SlideControl”, nc)
if(connected)
{
so.addEventListener(“onSync”, Delegate.create(this,
newMessageHandler));
status.text = “SlideControl Successful!!”
}
}
function newMessageHandler(evtObj:Object):Void
{
// we've been notified that there's a new message, go get it
var index = so.getData(“slideIndex”);
if(index == null) // this is first time, initialize to first slide
{
so.setData(“slideIndex”, 1)
return
}
slide_img.loadMovie(slideurl+“slide”+index+“.jpg”)
conntext.text = “Index: ” + index
}
// create slide control buttons ////////////
var x_offset = 80
var button_width = 70
var button_height = 30
var button_x = 160 //18
var button_y = 335 //350
createClassObject(Button, “prevB”,1 ,{label:“Prev Slide”});
prevB.setSize(button_width, button_height, noEvent)
prevB.move(button_x, button_y, noEvent)
prevB.addEventListener(“click”, movePrev);
prevB.enabled = false
button_x += x_offset
createClassObject(Button, “nextB”,2 ,{label:“Next Slide”});
nextB.setSize(button_width, button_height, noEvent)
nextB.move(button_x, button_y, noEvent)
nextB.addEventListener(“click”, moveNext);
button_x += x_offset
createClassObject(Button, “endB”,3 ,{label:“Stop Timer”});
endB.setSize(button_width, button_height, noEvent)
endB.move(button_x, button_y, noEvent)
endB.addEventListener(“click”, endCapture);
function moveNext( )
{
//trace(“You clicked the Next!”);
var index = so.getData(“slideIndex”)
index++
so.setData(“slideIndex”, index);
if(!prevB.enabled) prevB.enabled = true
}
function movePrev( )
{
//trace(“You clicked the Prvevious!”);
var index = so.getData(“slideIndex”)
index−−
if(index == 1) prevB.enabled = false
so.setData(“slideIndex”, index)
}
function endCapture( )
{
// Signal end of video section
so.setData(“slideIndex”, “−1”)
}
iniConnect( ) // initialize connection

Any variations of the above teaching are also intended to be covered by this patent application.

1. A system for collaborative and interactive communication and presentation over the internet or network, said system comprising:
a communication medium;
one or more servers;
a recording module;
multiple clients;
a presenter, presenting a presentation session; and
a presentation interface;
wherein said presenter further comprising:
a video source;
an audio source;
a presentation source;
a text source;
a webcasting unit; and
a presenter software;
wherein said presentation session comprising all the data from said video source, said audio source, said presentation source, and said text source;
wherein said communication medium is an Internet Protocol-based network;
wherein said one or more servers further comprising:
a presentation server;
a database server; and
a Web server;
wherein said multiple clients further comprising:
a computer; and
a Web browser;
wherein said Web browser comprising a presentation player plug-in;
wherein said video source, said audio source and said presentation source are connected to said Webcasting unit or a Web cam;
wherein said Webcasting unit or said Web cam is connected to said one or more servers via said communication medium;
wherein said multiple clients are connected to said presentation interface via said communication medium;
wherein said presentation interface is connected to said one or more servers;
wherein said recording module is connected to said one or more servers;
wherein said one or more servers receive data from said video source, said audio source and said presentation source, and simultaneously send the data to said multiple clients via said presentation interface and to said recording module for storage; and
wherein said clients view said presentation session on said Web browser.

2. A system as stated in claim 1, wherein said system comprising of a local recording module for storage and backup purpose.

3. A system as stated in claim 1, wherein said system comprising of a pre-chaptering interface for creating chapters at presentation time;

4. A system as stated in claim 1, wherein said system comprising of a pre-polling interface for polling clients at presentation time.

5. A system as stated in claim 3, wherein said pre-chaptering interface communicates with said Web server via said communication medium.

6. A system as stated in claim 4, wherein said pre-polling interface communicates with said Web server via said communication medium.

7. A system as stated in claim 1, wherein said one or more servers are attached to a Network Attached Storage.

8. A system as stated in claim 1, wherein said presentation source is a Microsoft PowerPoint file or Open-Office.

9. A system as stated in claim 1, wherein said Web browser of said multiple clients communicate with said Web server via HTTP/HTTPS protocols.

10. A system as stated in claim 1, wherein said presentation player of said multiple clients communicate with said presentation server via RTMP, RTMPT or RTMPS protocols.

11. A system as stated in claim 1, wherein said system is used as a Software-as-a-Service.

12. A system as stated in claim 1, wherein said presentation server communicates with said database server via JDBC protocol.

13. A system as stated in claim 1, wherein said database server is a MYSQL server.

14. A system as stated in claim 1, wherein said presentation server is based on Flash technology.

15. A system as stated in claim 1, wherein said Web server is an Apache server.

16. A system as stated in claim 1, wherein said system comprises an Adobe presentation Communication Server or Wowza Media Server.

17. A system as stated in claim 1, wherein said one or more servers are implemented on Sun's OpenSolaris operating system;

18. A system as stated in claim 1, wherein said one or more servers are implemented on Linux operating system.

19. A system as stated in claim 1, wherein said one or more servers are implemented on Windows operating system.

20. A system as stated in claim 1, wherein said one or more servers are implemented on Sun's Sun Fire servers.

21. A system as stated in claim 1, wherein said one or more servers are implemented on Sun's Ultra SPARC TI-based systems.

22. A system as stated in claim 1, wherein said system is locally installed at customer premise.

23. A system as stated in claim 1, wherein said system is installed at service provider premise and said presenter connects to said system via Internet.

24. A system as stated in claim 1, wherein said recording module is used to playback said recorded session for video on-demand viewing.

25. A system as stated in claim 1, wherein said presenter software is locally installed on one or more of said multiple clients.

26. A system as stated in claim 1, wherein said presenter software is installed on said Web server or a presenter's computer and accesses by one or more of said multiple clients via said communication medium.

27. A system as stated in claim 1, wherein said one or more servers are written in Java language.

28. A system as stated in claim 1, wherein said system is used in relation with a software module as a Service Webcast offering.

29. A system as stated in claim 1, wherein said system is integrated in to customer's registration system and LMS.

30. A system as stated in claim 1, wherein said system supports remote video switching between multiple video sources;

31. A system as stated in claim 1, wherein said system supports user-selectable video switching between multiple video sources;

32. A system as stated in claim 1, wherein multiple versions of said system is supported simultaneously for multiple customers.

33. A system as stated in claim 1, wherein said presentation server is a streaming server, and does not permit downloading of the said presentation session.

34. A system as stated in claim 1, wherein said system supports High Definition quality streaming video and audio.

35. A system as stated in claim 1, wherein said system supports polling said clients by said presenter.

36. A system as stated in claim 1, wherein said system supports showing the polling result to the presenter.

37. A system as stated in claim 1, wherein said multiple clients ask questions from said presenter and get the answers from said presenter.

38. A system as stated in claim 1, wherein said system supports viewing of said presentation session by said multiple clients, as soon as said presentation session is over, as Video-on-Demand.

39. A system as stated in claim 1, wherein said system is used in an educational environment, simulating a classroom, wherein said multiple clients are students, who see said presenter and a presentation material, and interactively, ask questions and get their answers.

40. A system as stated in claim 1, wherein said system is used in a corporate environment, simulating a conference room or a board meeting, where one or more of said presenters present, and said multiple clients interactively ask questions and get their answers.
